(19) United States
(12) Patent Application Publication
(10) Pub. No.: US 2011/0119976 A1
(43) Pub. Date: May 26, 2011

(54) ADJUSTABLE DISPLAY BOARD SYSTEM

(76) Inventors: Jorge Garcia, Independence, MO (US); Carl Redden, Gypsum, KS (US)

(21) Appl. No.: 12/624,070

(22) Filed: Nov. 23, 2009

(51) Int. Cl. G09F 15/00

(52) U.S. Cl. 40/606.14

(57) ABSTRACT

An adjustable display board system comprises a board frame, a mounting frame, a positioning mechanism, and a counterbalancing mechanism. The board frame retains a display board. The mounting frame is coupled to the board frame to allow vertical motion of the board frame and attaches to a rigid structure that supports the system. The positioning mechanism controls the vertical position of the board frame and includes a latched mode that prevents vertical motion of the board frame. The counterbalancing mechanism prevents the board frame and the display board from falling when the positioning mechanism is not in the latched mode.

### BACKGROUND OF THE INVENTION

1. Field of the Invention

Embodiments of the present invention relate to display boards, such as erasable white boards. More particularly, embodiments of the present invention relate to position-adjustable display boards.

2. Description of the Related Art

A board for displaying information, such as a white board, is routinely mounted to a wall in a fixed position. The board may be hung with brackets, or other mounting components so that it is rigidly attached to the wall and positioned at a nominal height that is convenient for many people. However, the board may be positioned at too great a height for shorter people to easily reach all areas of the board or to low for taller people to comfortably reach the lower portions of the board.

### SUMMARY OF THE INVENTION

Embodiments of the present invention provide a distinct advance in the art of boards for displaying information. More particularly, embodiments of the invention provide a display board system that is easily adjustable to a desired and convenient height.

In one embodiment of the system, the display board system may comprise a board frame, a mounting frame, a positioning mechanism, and a counterbalancing mechanism. The board frame retains a display board. The mounting frame may attach to a rigid structure that supports the system and may include a plurality of stationary rollers configured to engage the board frame as well as a plurality of guides configured to minimize inward and outward rocking of the board frame while the board frame is in motion. The positioning mechanism may control the vertical position of the board frame and may include a knob coupled to a latching unit to provide a latched mode that prevents vertical motion of the board frame, wherein rotation of the knob engages and disengages the latched mode. The counterbalancing mechanism may include a gas spring configured to generate a force that is proportional to the weight of the board frame and the display board to prevent the board frame and the display board from falling when the positioning mechanism is not in the latched mode.

In another embodiment of the system, the display board system may comprise a board frame, a mounting frame, a positioning mechanism, and a counterbalancing mechanism. The mounting frame may attach to a rigid structure that supports the system and may include a plurality of stationary rollers configured to engage the board frame as well as a plurality of guides configured to minimize inward and outward rocking of the board frame while the board frame is in motion. The positioning mechanism may control the vertical position of the board frame and may include an actuator arm coupled to a pin to provide a latched mode that prevents vertical motion of the board frame, wherein rotation of the actuator arm engages and disengages the latched mode. The counterbalancing mechanism may include a gas spring configured to generate a force that is proportional to the weight of the board frame and the display board to prevent the board frame and the display board from falling when the positioning mechanism is not in the latched mode.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention is described in detail below with reference to the attached drawing figures, wherein:

FIG. 1 is an isometric view of an adjustable display board system constructed in accordance with a first embodiment of the current invention;

FIG. 2 is an isometric view of a mounting frame and a portion of a positioning mechanism of the adjustable display board system;

FIG. 3 is an isometric view of a board frame and a portion of the positioning mechanism of the adjustable display board system;

FIG. 4 is a fragmentary view of upper left portions of the mounting frame and the board frame retaining the display board;

FIG. 5 is a fragmentary view of rear portions of the mounting frame, the board frame, and a latching unit;

FIG. 6 is a rear plan view of the system showing the board frame in a middle position with respect to the mounting frame;

FIG. 7 is a rear plan view of the system showing the board frame in a lower position with respect to the mounting frame;

FIG. 8 is a rear plan view of the system showing the board frame in an upper position with respect to the mounting frame; and

FIG. 9 is a rear plan view of a second embodiment of the positioning mechanism and the board frame.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

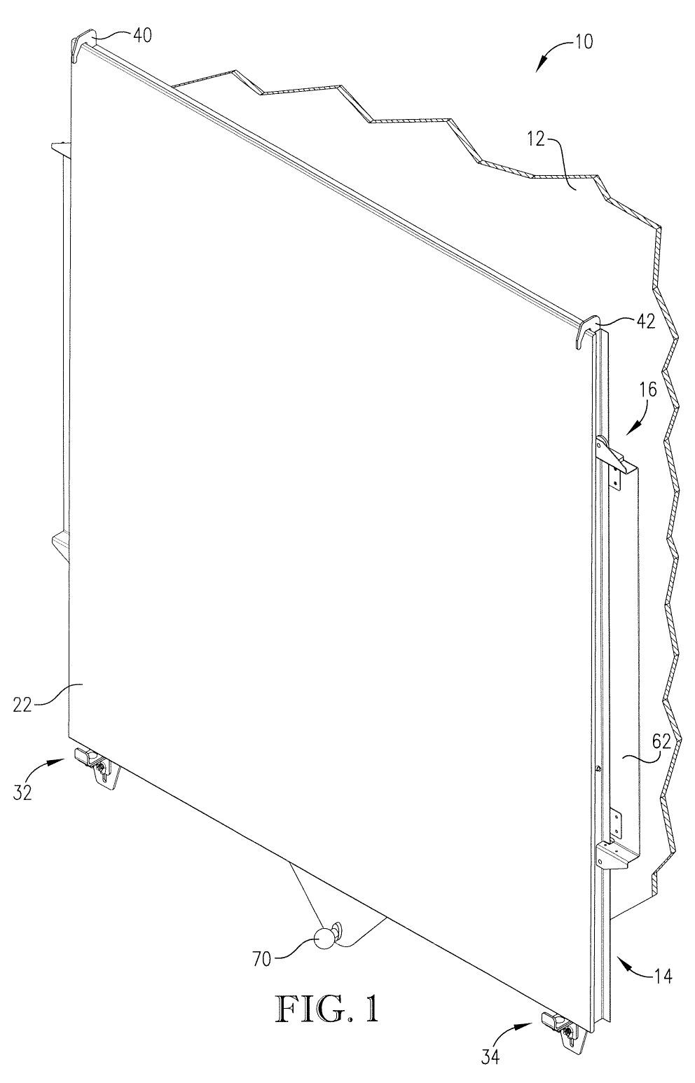

FIGS. 1-9 show an adjustable display board system 10, or portions thereof, constructed in accordance with various embodiments of the present invention. The display board system 10 may be utilized in locations where individuals need to convey information to other individuals or groups—such as schools, libraries, churches, meeting halls, civic or government buildings, business settings, such as board rooms or strategy rooms, and the like. The display board system 10 may be mounted to a rigid structure 12 that will support the weight of the system 10. Typically, the rigid structure 12 is a wall, although other structures are possible, such as a door.

An embodiment of the system 10 is shown in FIGS. 1 and 6-8, and may broadly comprise a board frame 14, a mounting frame 16, a positioning mechanism 18, and a counterbalancing mechanism 20.

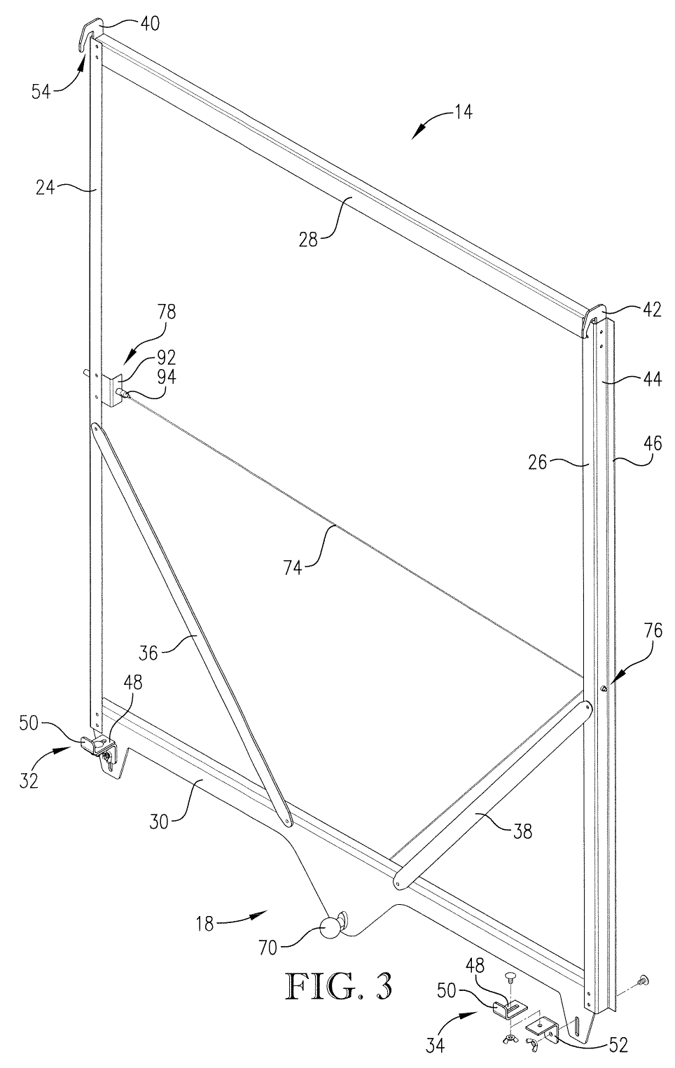

The board frame 14 may be capable of holding or retaining a display board 22, as seen in FIG. 1. In general, the display board 22 may include any board for displaying information, such as chalkboards, bulletin boards, display cases, tackboards, notice boards, letter boards, cork boards, and the like. The board frame 14, as seen in FIG. 3, may be of general rectangular shape with a left rail 24, a right rail 26, a top beam 28, a bottom beam 30, a left board clamp 32, a right board clamp 34, a left gusset 36, a right gusset 38, a left board hook 40, and a right board hook 42. All the components of the board frame 14 may be manufactured from metal, such as steel, aluminum, or the like, although other materials or combinations of materials are possible.

The left rail 24 and the right rail 26 may be thin, elongated, spaced apart from one another, and vertically oriented. The left rail 24 and the right rail 26 may include a track 44 on the sidewalls of the rails 24, 26. The track 44 may include a pocket, a channel, or the like that extends the length of each rail 24, 26 and couples with the mounting frame 16, as discussed in further detail below. Adjacent to each track 44 may be a flange 46, extending away from the track 44 generally parallel to the rigid structure 12.

The top beam 28 may be thin and elongated with opposing ends that couple to the upper end of the left rail 24 and the right rail 26. The bottom beam 30 may couple to the lower end of the left rail 24 and the right rail 26. The left board clamp 32 may be coupled to the left end of the bottom beam 30, and the right board clamp 34 may be coupled to the right end of the bottom beam 30. The left board clamp 32 and the right board clamp 34 in combination generally retain the lower end of the display board 22 and may both include a tray 48 and a lip 50. The tray 48 may be generally rectangular in shape and extend outward from the bottom beam 30. The lip 50 may extend upward from the outer edge of the tray 48. Both the left board clamp 32 and the right board clamp 34 may be coupled to the bottom beam 30 through a right-angle bracket 52 that allows the left board clamp 32 and the right board clamp 34 to be adjusted both vertically to accommodate the height of the display board 22 and outwardly with respect to the board frame 14 to accommodate the thickness of the board 22.

The left gusset 36 and the right gusset 38 may be thin and elongated with the left gusset 36 connected from near the center of the bottom beam 30 to near the center of the left rail 24 and the right gusset 38 connected from near the center of the bottom beam 30 to near the center of the right rail 26. The left gusset 36 and the right gusset 38 generally provide mechanical stability for the board frame 14.

The left board hook 40 may be coupled to the upper end of the left rail 24, and the right board hook 42 may be coupled to the upper end of the right rail 26. The left board hook 40 and the right board hook 42 may extend outward from the left rail 24 and the right rail 26, respectively, and arch downward creating an internal opening 54, as seen in FIGS. 1, 3, and 4. The upper edge of the display board 22 may be inserted into the opening 88 of the left board hook 40 and the right board hook 42 when the display board 22 is installed into the adjustable display board system 10.

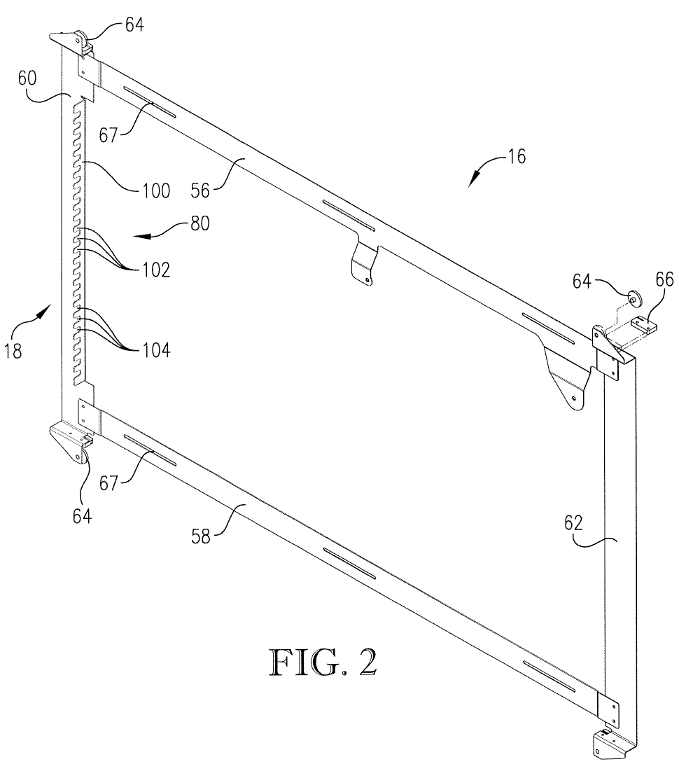

The mounting frame 16, as seen in FIG. 2, generally retains the board frame 14 to the rigid structure 12. The mounting frame 16 may include an upper brace 56, a lower brace 58, a left brace 60, a right brace 62, a plurality of rollers 64, and a plurality of guides 66.

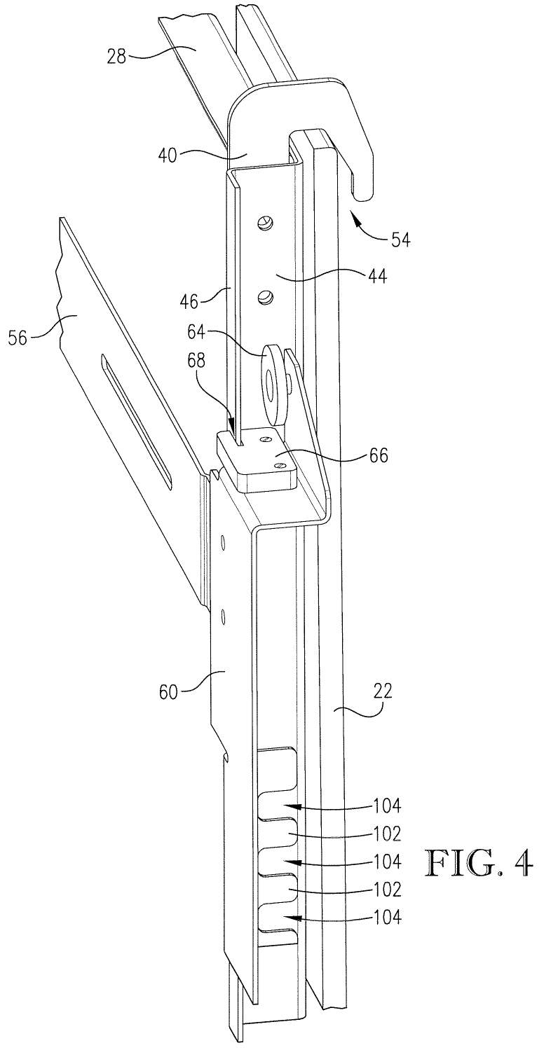

The upper brace 56 and the lower brace 58 may be elongated and horizontally oriented, each including a plurality of mounting slots 67 through which screws, nails, or similar fasteners may be placed in order to securely attach the upper brace 56 and the lower brace 58, and in turn the mounting frame 16, to the rigid structure 12. The left brace 60 and the right brace 62 may be spaced apart from one another and coupled to opposing ends of the upper brace 56 and the lower brace 58. A roller 64, as seen in FIGS. 2 and 4, may be positioned at the upper end and lower end of the left brace 60 and the right brace 62 for a total of four rollers 64. Each roller 64 may be circular, disc, or wheel shaped and capable of rotating as the board frame 14 is in motion with the axis of rotation generally oriented normal to the mounting frame 16. The rollers 64 may engage the tracks 44 located on the sidewalls of the left rail 24 and the right rail 26. A guide 66, as seen in FIGS. 2 and 4, may be positioned adjacent to each roller 64. Each guide 66 may include a groove 68 that receives the flange 46 and limits rocking motion inward and outward with respect to the rigid structure 12 of the board frame 14 and the display board 22. The engagement of the rollers 64 and the guides 66 with the tracks 44 and the flanges 46 allows the board frame 14 and the display board 22 to travel or slide up and down (in the vertical direction) with respect to the mounting frame 16 and the rigid structure 12. The rollers 64 and the guides 66 remain generally rigidly positioned as the board frame 14 is in motion.

The positioning mechanism 18, as seen in FIGS. 2 and 3, generally controls the vertical position of the board frame 14 and the display board 22 with respect to the mounting frame 16 and the rigid structure 12. The positioning mechanism 18 may allow or may inhibit vertical motion of the board frame 14 and display board 22. The positioning mechanism 18 may include a knob 70, a cable arm 72, a cable 74, an eyebolt 76, a latching unit 78, and a locking rack 80.

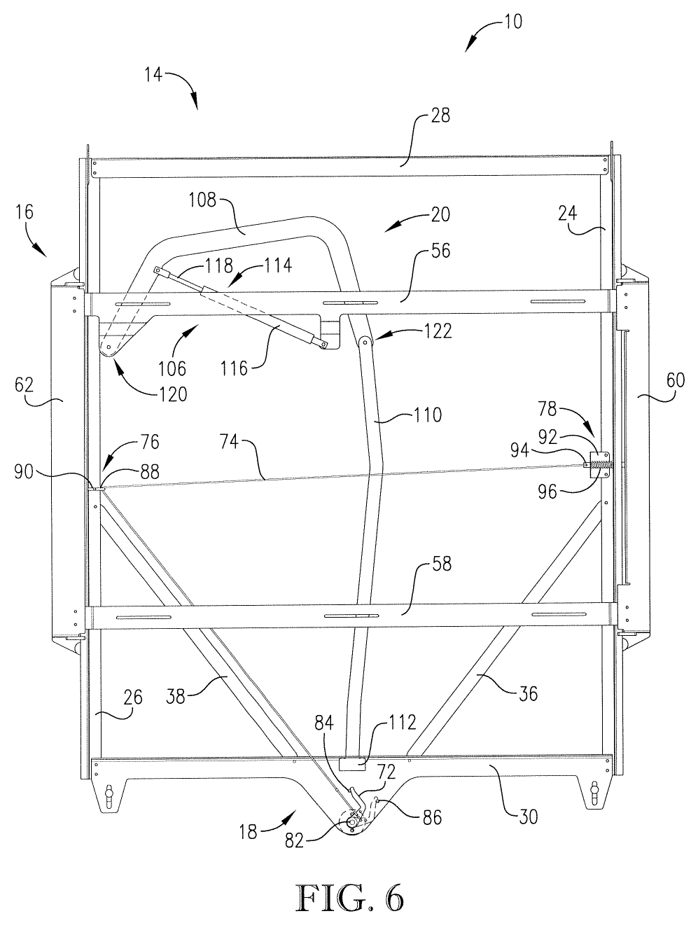

The knob 70 may be of traditionally rounded or oval shape, although other shapes or even devices, such as a handle or lever, are possible. The knob 70 may be coupled on the outer side of the board frame 14 to a proximal end of a shaft 82, which in turn may be attached to the center of the bottom beam 30. The cable arm 72 may be coupled to a distal end of the shaft 82 on the inner side of the board frame 14. The cable arm 72 may extend radially outward from the shaft 82 and may be bent along the length of the arm 72. The knob 70 may be rotated in order to adjust the height of the board 22, as described in more detail below. The free end of the cable arm 72 may travel in a path along an arc that corresponds to the rotation of the knob 70. There may also be a first stop 84 and a second stop 86 positioned at the opposing ends of travel of cable arm 72 that limit the distance of travel, as seen in FIGS. 6-8.

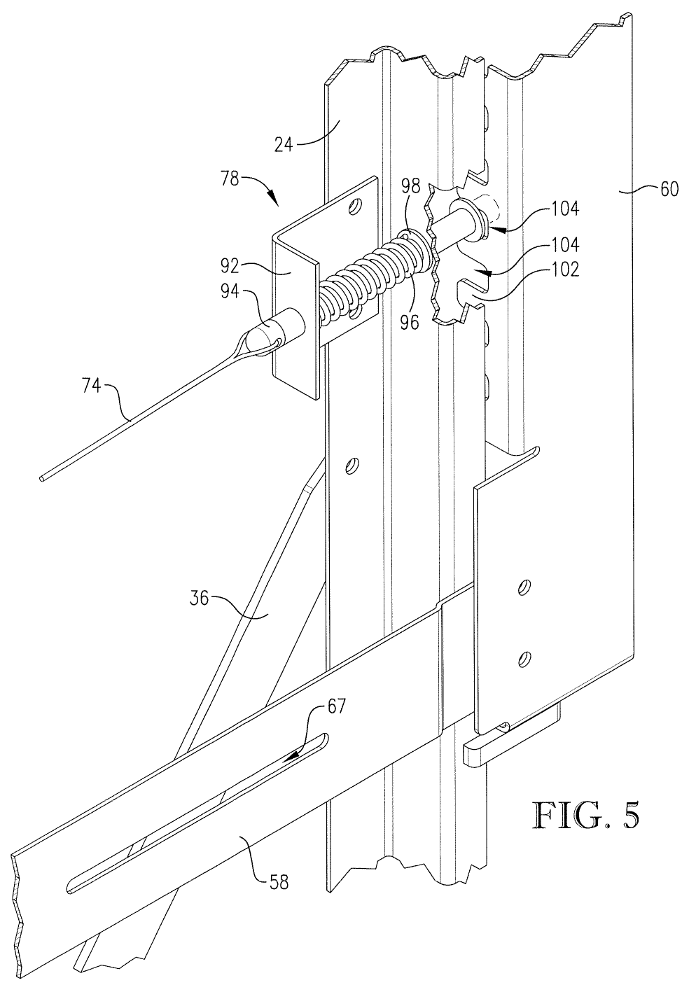

The eyebolt 76 may include a circular opening 88 with a threaded shaft 90 extending radially from the opening 88. The shaft 90 of the eyebolt 76 may be coupled to the right rail 26 approximately midway along the length of the right rail 26. The latching unit 78, as seen in FIGS. 3 and 5, may be positioned on the left rail 24 opposite the eyebolt 76 and slightly farther away from the knob 70 than the eyebolt 76. The latching unit 78 may determine a latched or an unlatched state of the positioning mechanism 18 and may include a case 92, a pin 94, and a first spring 96. The case 92 may be coupled to the left rail 24 and may include an opening 88 through which the pin 94 is placed. The pin 94 may also extend through the left rail 24. Encircling the cylindrical pin 94 may be the first spring 96, which may be positioned between the case 92 and the left rail 24. Positioned between the first spring 96 and the left rail 24 may be a ring 98 that is rigidly attached to the pin 94.

The cable 74 may be manufactured from strong but flexible material, such as stranded wire or the like. A first end of the cable 74 may be connected to the cable arm 72 near the shaft 82. A portion of the cable 74 near the center of the length of the cable 74 may be positioned through the opening 88 of the eyebolt 76. A second end of the cable 74 may be connected to the pin 94.

The locking rack 80 may include a base 100, a plurality of teeth 102, and a plurality of spaces 104, as seen in FIG. 2. The base 100 may be thin and elongated and coupled to the left brace 60 of the mounting frame 16 such that the base 100 is generally vertically oriented. The teeth 102 may be coupled to the base 100 such that the teeth 102 protrude outward, normal to the left brace 60. Each tooth 102 may include opposing edges that are separated by a distance approximately equal to the diameter of the pin 94. The teeth 102 may be interleaved on the base 100 by the spaces 104, wherein each space 104 may also be approximately equal to the diameter of the pin 94. When the positioning mechanism 18 is latched, the pin 94 may be positioned within the space 104 between any two adjacent teeth 102.

The positioning mechanism 18 may operate as follows. The knob 70 may be rotated causing the cable arm 72 to move away from the first stop 84 and encounter the second stop 86. The motion of the cable arm 72 pulls on the cable 74, which moves through the eyebolt 76 and pulls on the pin 94. The pin 94 may be pulled inward away from the locking rack 80 such that the pin 94 is clear from the teeth 102. Inward motion of the pin 94 may also move the ring 98 to compress, or further compress, the first spring 96. At this point, the positioning mechanism 18 is unlatched. The board 22 may be moved up or down to a new position. Then, the knob 70 may be rotated in the opposite direction back to its original position. The rotation may also be accomplished by releasing the knob 70. The compression of the first spring 96 may push the pin 94 outward to the space 104 between two adjacent teeth 102. In turn, the cable 74 may also be pulled in the opposite direction through the eyebolt 76, which rotates the cable arm 72 back to the first stop 84.

The counterbalancing mechanism 20, as seen in FIGS. 6-8, generally prevents the display board 22 and the board frame 14 from being pulled down by their own weight or falling when the positioning mechanism 18 is unlatched by generating an opposing force roughly equal to the weight of the display board 22 and the board frame 14. The counterbalancing mechanism 20 may include a lift spring 106, a lift arm 108, a lift link 110, and a lift block 112.

The lift spring 106 may generate a lifting force that is proportional to the weight of the display board 22 and the board frame 14. The amount of force may depend on how the lift spring 106 is implemented in the counterbalancing mechanism 20, as explained below. The lift spring 106 may include a gas spring 114 in order to provide a generally constant force through the range of vertical motion of the display board 22. The gas spring 114 also may maintain its shape while in use, may provide shock absorption, and may provide a stop for the vertical motion of the display board 22 and the board frame 14. The gas spring 114 may include a cylinder 116 and a rod 118, wherein the rod 118 may slidably extend in and out of the cylinder 116. An example of the gas spring 114 may be the #9416K175 that provides a 120-pound force from McMaster-Carr of Robbinsville, N.J.

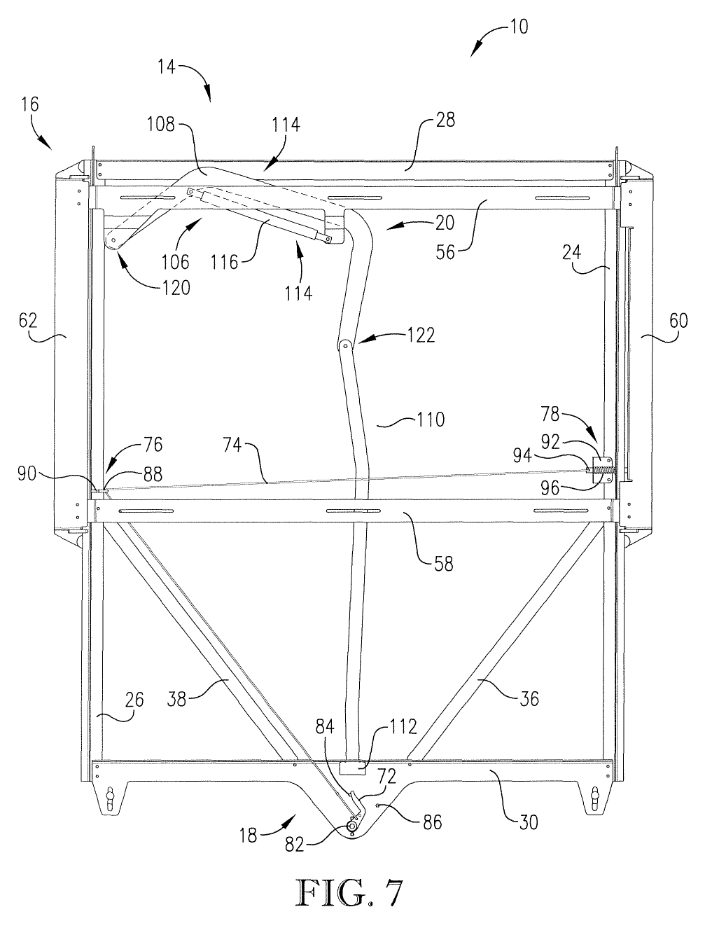

The cylinder 116 may be coupled to the central region of the upper brace 56 such that the cylinder 116 may rotate about that point. The rod 118 may be rotatably coupled to a position on the lift arm 108. The lift arm 108 may be rigid, elongated and include a general curvature or arcuate shape with a first end 120 being rotatably coupled to the right side of the upper brace 56 to form a linkage. A second, opposing end 122 of the lift arm 108 may be rotatably coupled to one end of the lift link 110, which may be vertically oriented near the central vertical axis of the mounting frame 16. The arcuate shape of the lift arm 108 allows the second end 122 of the arm 108 to be positioned below the first end 120 as the board frame 14 is being lowered, as seen in FIG. 7, also allowing the board frame 14 to reach a lower position than if the lift arm 108 were straight. The opposing, lower end of the lift link 110 may couple to or be integrated with the lift block 112, which in turn may couple or lock with the center of the bottom beam 30 of the board frame 14. The lift block 112 may be generally rectangular in shape with rounded upper corners that interact with the bottom beam 30 to minimize rocking or wobble of the board frame 14 and the display board 22 during vertical motion of the two.

The gas spring 114 exerts a first torque on the lift arm 108. The combinational weight of the lift link 110, the board frame 14, and the display board 22 exerts a second, opposing torque on the lift arm 108. In a static situation, the first torque and the second torque must be roughly equivalent. The first torque depends on the force of the gas spring 114 and the distance from where the rod 118 couples with the lift arm 108 to where the lift arm 108 is attached to the upper brace 56. The second torque depends on the combinational weight and the length of the lift arm 108. Thus, to accommodate the varying weights of different display boards 22, either the force of the gas spring 114 may be adjusted or the position along the lift arm 108 where the rod 118 of the gas spring 114 is coupled may be adjusted.

The adjustable display board system 10 may operate as follows. The system 10 may be mounted on a rigid structure 12, such as a wall, and seen in the exemplary embodiment of FIG. 1. The left board clamp 32 and the right board clamp 34 may be at their lowest positions or may be temporarily removed from the bottom beam 30. A display board 22 may be installed in the system 10 by inserting the upper edge of the display board 22 into the internal opening 54 of the left board hook 40 and the right board hook 42. With the board 22 held up against the left board hook 40 and the right board hook 42 and flat against the left rail 24 and the right rail 26, the left board clamp 32 and the right board clamp 34 may be adjusted vertically for the height of the board 22 and outwardly for the thickness of the board 22.

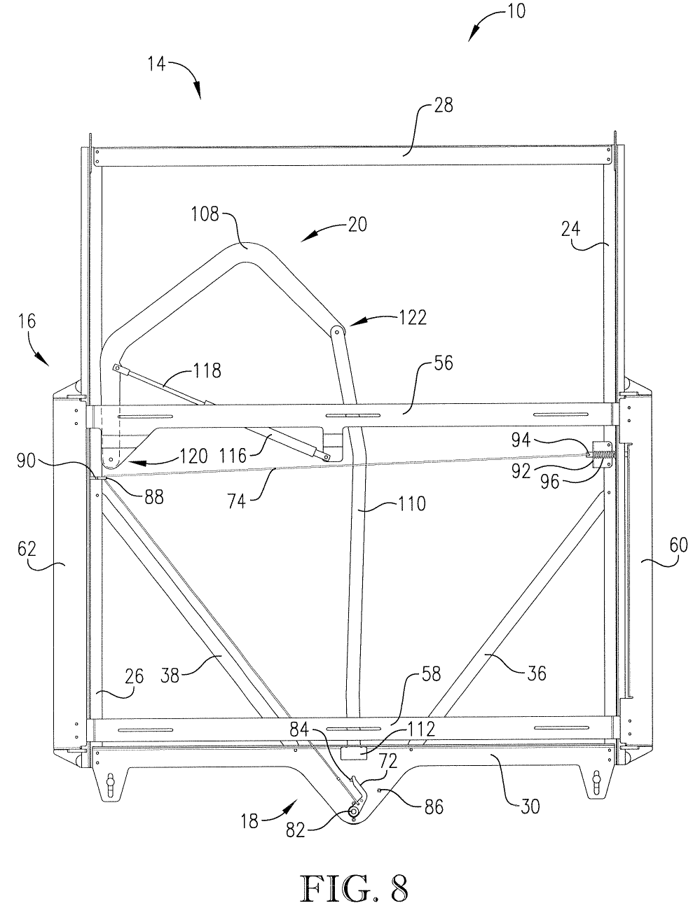

The height of the display board 22 may be adjusted by rotating the knob 70 in one direction, either raising or lowering the board 22 and the board frame 14 to the desired height, and then rotating the knob back in the opposite direction to its original position. The board frame 14, excluding the display board 22, is shown at three different heights in FIGS. 6-8. In FIG. 6, the board frame 14 is positioned at a middle height. In FIG. 7, the board frame 14 is positioned at a lower height. In FIG. 8, the board frame 14 is positioned at an upper height.

Rotation of the knob 70 moves the cable arm 72 from the first stop 84 to the second stop 86 and pulls the cable 74, which in turn pulls the pin 94 inward, away from the locking rack 80 and clear from the teeth 102. The first spring 96 of the latching unit 78 also becomes compressed. With the knob 70 fully rotated and the pin 94 clear of the teeth 102, the positioning mechanism 18 is unlatched. The board 22 may not move or fall due to its own weight, because the counterbalancing mechanism 20 generates an upward force on the board frame 14 to offset the downward force of the weight of the board 22. While the positioning mechanism 18 is unlatched, the knob 70 may be pulled upward or pushed downward to move the board 22. The board frame 14 also moves, with the tracks 44 of the left rail 24 and the right rail 26 being engaged with the rollers 64 and guides 66 of the left brace 60 and the right brace 62.

When the desired position of the board 22 is reached, the knob 70 is rotated to its original position, or may simply be released. The first spring 96 of the latching unit 78 may push the pin 94 outward, in turn pulling the cable 74 which rotates the cable arm 72 and the knob 70 back to its original position. It may be possible that at a specific vertical position of the board 22, the pin 94 may not align with the space 104 between two adjacent teeth 102. In this case, the board 22 may be adjusted up or down slightly until the pin 94 fits into the space 104 between two adjacent teeth 102, and the positioning mechanism 18 is latched.

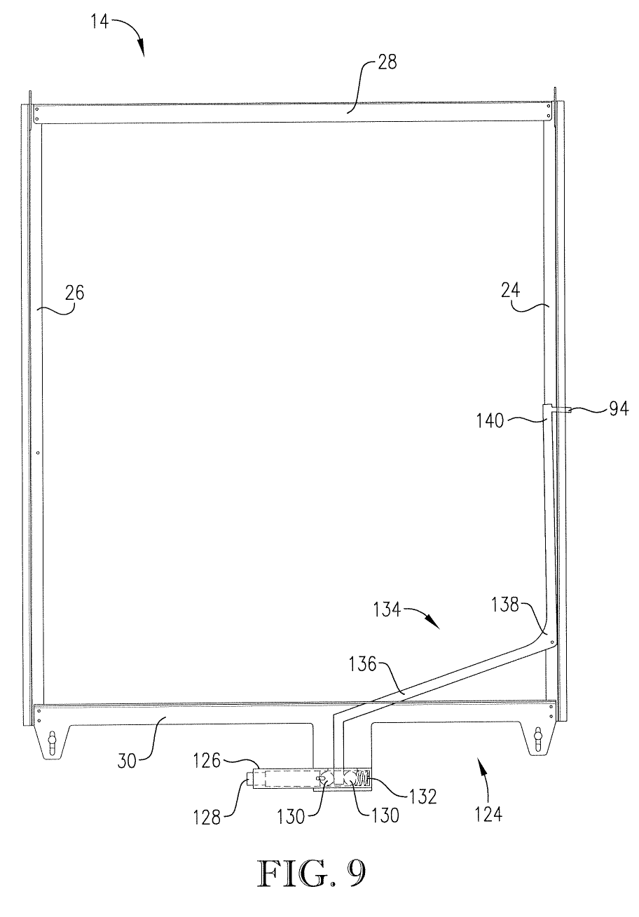

Another embodiment of the adjustable display board system 10 may comprise a board frame 14, a mounting frame 16, and a counterbalancing mechanism 20 substantially similar to those described above. A positioning mechanism 124, as shown in FIG. 9, may differ from the positioning mechanism 18 described above and may include a handle 126, a plunger 128, a plurality of bearings 130, a second spring 132, an actuator arm 134, and the locking rack 80, as disclosed above.

The handle 126 may be elongated, cylindrical, and horizontally oriented. A portion of the handle 126 may be coupled to the bottom beam 30 of the board frame 14. The plunger 128 may be of similar cross-sectional shape to the handle 126, but smaller in size such that the plunger 128 may be slidably positioned within the handle 126. One end of the plunger 128 may protrude from an open end of the handle 126. The other end of the plunger 128 may contact a first bearing 130 within the handle 126. A second bearing 130 may also be positioned within the handle 126 and may contact the second spring 132, which may be positioned firmly against a closed end of the handle 126.

The actuator arm 134 may be rigid and may include a lower portion 136 coupled to an elbow 138, which in turn is coupled to an upper portion 140. The lower portion 136 may also be inserted into the handle 126, such that it is positioned between and in contact with both the first bearing 130 and the second bearing 130. The elbow 138 may be pivotally coupled to the back side of the left rail 24. The upper portion 140 may be oriented at an angle between 90° and 180° with respect to the lower portion 136. Attached to the end of the upper portion 140 at nearly a right angle may be the pin 94, which is similar in orientation, shape, and function as described above.

The second embodiment of the adjustable display board system 10 may operate as follows. To adjust the vertical position of the board 22, the portion of the plunger 128 protruding from the handle 126 may be pushed into the handle 126. The board 22 may be raised or lowered by pulling or pushing on the handle. At the desired height, the plunger 128 may be released.

Pushing in on the plunger 128 may exert a first force on the lower portion 136 of the actuator arm 134, in turn causing the actuator arm 134 to pivot about the elbow 138, and furthermore, compressing the second spring 132. Accordingly, the upper portion 140 of the actuator arm 134 moves away from the left rail 24—thus pulling the pin 94 out from the locking rack 80 and clear of the teeth 102. The positioning mechanism 124 is unlatched at this point. After the board 22 is moved to the desired height, the plunger 128 may be released which removes the first force on the lower portion 136 of the actuator arm 134. However, the second spring 132, in trying to uncompress, exerts a second force on the lower portion 136 in the opposite direction as the first force. Therefore, the upper portion 140 of the actuator arm 134 pivots back toward the left rail 24 and pushes the pin 94 back into the space 104 between two adjacent teeth 102, which latches the positioning mechanism 124. The board 22 may need to be adjusted slightly up or down in order for the pin 94 to properly align with the space 104 between two adjacent teeth 102.

Various embodiments of the current invention may be also used to provide a height-adjustable apparatus that can support storage elements such as spice racks, dish racks, spare parts racks, medicine cabinets, supply cabinets, and the like. Instead of the display board 22, the storage element may be attached to the board frame 14, as disclosed above, with perhaps additional fastening components. The system then allows the storage element to be raised and lowered in the same manner as the display board 22.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An adjustable display board system, the system comprising:
a board frame configured to retain a display board;
a mounting frame configured to attach to a rigid structure that supports the system, the mounting frame coupled to the board frame to allow vertical motion of the board frame;
a positioning mechanism configured to control the vertical position of the board frame, the positioning mechanism including a latched mode that prevents vertical motion of the board frame; and
a counterbalancing mechanism configured to prevent the board frame and the display board from falling when the positioning mechanism is not in the latched mode.

2. The system of claim 1, wherein the positioning mechanism further includes a knob coupled to a latching unit to provide the latched mode, wherein rotation of the knob engages and disengages the latched mode.

3. The system of claim 2, wherein the positioning mechanism further includes a locking rack with a plurality of teeth and interleaved spaces and the latching unit further includes a pin that is positioned within the space between two adjacent teeth when the positioning mechanism is in the latched mode.

4. The system of claim 3, wherein the knob is coupled to the pin such that rotation of the knob in one direction removes the pin from the space between two adjacent teeth and rotation of the knob in opposite direction replaces the pin in the space between two adjacent teeth.

5. The system of claim 1, wherein the counterbalancing mechanism further includes a gas spring configured to generate a force that is proportional to the weight of the board frame and the display board.

6. The system of claim 5, wherein the counterbalancing mechanism further includes a lift arm with a first end rotatably coupled to the mounting frame and a second end coupled to the board frame through a lift link, such that the gas spring exerts a torque on the lift arm.

7. The system of claim 1, wherein the mounting frame further includes at least one roller on the left side of the mounting frame and at least one roller on the right side of the mounting frame such that the rollers engage the board frame during motion of the board frame.

8. The system of claim 7, wherein the board frame further includes a left vertical rail and a right vertical rail, each including a track configured to receive at least one roller.

9. The system of claim 8, wherein the mounting frame further includes at least one guide on the left side of the mounting frame and at least one guide on the right side of the mounting frame such that the guides minimize inward and outward rocking of the board frame while the board frame is in motion.

10. The system of claim 9, wherein the left vertical rail and the right vertical rail each further include a flange configured to engage a groove of at least one guide.

11. An adjustable display board system, the system comprising:
a board frame configured to retain a display board;
a mounting frame configured to attach to a rigid structure that supports the system, the mounting frame including a plurality of stationary rollers configured to engage the board frame and a plurality of guides configured to minimize inward and outward rocking of the board frame while the board frame is in motion;
a positioning mechanism configured to control the vertical position of the board frame, the positioning mechanism including a knob coupled to a latching unit to provide a latched mode that prevents vertical motion of the board frame, wherein rotation of the knob engages and disengages the latched mode; and
a counterbalancing mechanism including a gas spring configured to generate a force that is proportional to the weight of the board frame and the display board to prevent the board frame and the display board from falling when the positioning mechanism is not in the latched mode.

12. The system of claim 11, wherein the positioning mechanism further includes a locking rack with a plurality of teeth and interleaved spaces and the latching unit further includes a pin that is positioned within the space between two adjacent teeth when the positioning mechanism is in the latched mode.

13. The system of claim 12, wherein the knob is coupled to the pin such that rotation of the knob in one direction removes the pin from the space between two adjacent teeth and rotation of the knob in opposite direction replaces the pin in the space between two adjacent teeth.

14. The system of claim 11, wherein the counterbalancing mechanism further includes a lift arm with a first end rotatably coupled to the mounting frame and a second end coupled to the board frame through a lift link, such that the gas spring exerts a torque on the lift arm.

15. The system of claim 11, wherein the board frame further includes a left vertical rail and a right vertical rail, each including a track configured to receive at least one roller.

16. The system of claim 15, wherein the left vertical rail and the right vertical rail each further include a flange configured to engage a groove of at least one guide.

17. An adjustable display board system, the system comprising:
a board frame configured to retain a display board;
a mounting frame configured to attach to a rigid structure that supports the system, the mounting frame including a plurality of stationary rollers configured to engage the board frame and a plurality of guides configured to minimize inward and outward rocking of the board frame while the board frame is in motion;
a positioning mechanism configured to control the vertical position of the board frame, the positioning mechanism including an actuator arm coupled to a pin to provide a latched mode that prevents vertical motion of the board frame, wherein rotation of the actuator arm engages and disengages the latched mode; and
a counterbalancing mechanism including a gas spring configured to generate a force that is proportional to the weight of the board frame and the display board to prevent the board frame and the display board from falling when the positioning mechanism is not in the latched mode.

18. The system of claim 17, wherein the actuator arm further includes an elbow coupled to the board frame about which the actuator arm rotates.

19. The system of claim 17, wherein the positioning mechanism further includes a plunger slidably positioned within a handle, wherein pushing the plunger into the handle initiates rotation of the actuator arm.

20. The system of claim 17, wherein the positioning mechanism further includes a locking rack with a plurality of teeth and interleaved spaces such that the pin is positioned within the space between two adjacent teeth when the positioning mechanism is in the latched mode.

21. The system of claim 17, wherein the counterbalancing mechanism further includes a lift arm with a first end rotatably coupled to the mounting frame and a second end coupled to the board frame through a lift link, such that the gas spring exerts a torque on the lift arm.
